(19) United States
(12) Patent Application Publication
(10) Pub. No.: US 2023/0005347 A1
(43) Pub. Date: Jan. 5, 2023

(54) PORTABLE ALARM DEVICE

(71) Applicant: Laura Corona, Los Angeles, CA (US)

(72) Inventor: Laura Corona, Los Angeles, CA (US)

(21) Appl. No.: 17/702,254

(22) Filed: Mar. 23, 2022

Related U.S. Application Data
(60) Provisional application No. 63/218,478, filed on Jul. 5, 2021.

(51) Int. Cl. G08B 13/22; H04W 4/029; G06F 21/32

(52) U.S. Cl. CPC G08B 13/22; H04W 4/029; G06F 21/32

(57) ABSTRACT

A portable alarm device connected to a mobile device, the portable alarm including a main body having a hand held size, at least one sensor disposed on and within at least a portion of the main body to illuminate a color in response to detecting movement within a predetermined distance therefrom, and a communication unit disposed on and within at least a portion of the main body to transmit an alert signal from the at least one sensor to the mobile device in response to the at least one sensor detecting movement within the predetermined distance.

### CROSS-REFERENCE TO RELATED APPLICATIONS

This application claims priority under 35 USC § 120 from U.S. Provisional Application No. 63/218,478, entitled “Portable Alarm Device,” which was filed on Jul. 5, 2021, in the United States Patent and Trademark Office, the disclosure of which is incorporated herein in its entirety by reference.

### BACKGROUND

### 1. Field

The present general inventive concept relates generally to alarm systems, and particularly, to a portable alarm device.

### 2. Description of the Related Art

When it comes to travel, there are many options available for a traveler to obtain hospitality accommodations. Although hotels are the most common type of hospitality accommodation, guest homes and/or private home rentals are also popular. Notwithstanding the lower cost and privacy offered by private home rentals, security and/or trust can be a greater concern because sometimes a homeowner of the private home rental will unexpectedly return to the private home rental and/or simply the neighborhood is unfamiliar to the traveler.

As such, the probability of theft is significantly increased while traveling. Since the traveler is often on vacation while traveling, the security risk can create an inconvenient and/or a stressful concern for the traveler. Moreover, the traveler is dependent on the private home rental having an adequate security system.

Therefore, there is a need for a portable alarm device that is controlled by the traveler to alert the traveler of a security breach.

### SUMMARY

The present general inventive concept provides a portable alarm device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a portable alarm device connected to a mobile device, the portable alarm device including a main body having a hand held size, at least one sensor disposed on and within at least a portion of the main body to illuminate a color in response to detecting movement within a predetermined distance therefrom, and a communication unit disposed on and within at least a portion of the main body to transmit an alert signal from the at least one sensor to the mobile device in response to the at least one sensor detecting movement within the predetermined distance.

The communication unit may include a camera to move from retracted within the main body to at least partially extended away from the main body in response to the at least one sensor transmitting the alert signal, such that the camera records at least one of at least one image and at least one video thereon based on the at least one sensor detecting movement.

The portable alarm device may further include at least one biometric reader disposed within at least a portion of the main body to scan at least one of a finger and a toe and store a biometric reading of at least one of the finger and the toe on a storage unit based on at least one unauthorized user contacting the main body.

The at least one biometric reader may scan using an entire outer surface of the main body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of a portable alarm device, according to an exemplary embodiment of the present general inventive concept; and

FIG. 2 illustrates a rear perspective view of the portable alarm device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Portable Alarm Device 100
Main Body 110
Sensor 120
Communication Unit 130
Storage Unit 140
Biometric Reader 150
Clip 160
Power Button 170
Power Source 180
Charging Port 190

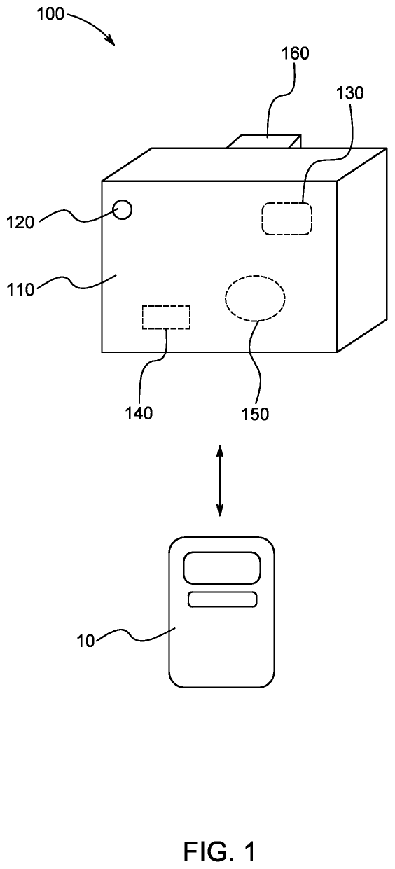

FIG. 1 illustrates a front perspective view of a portable alarm device 100, according to an exemplary embodiment of the present general inventive concept.

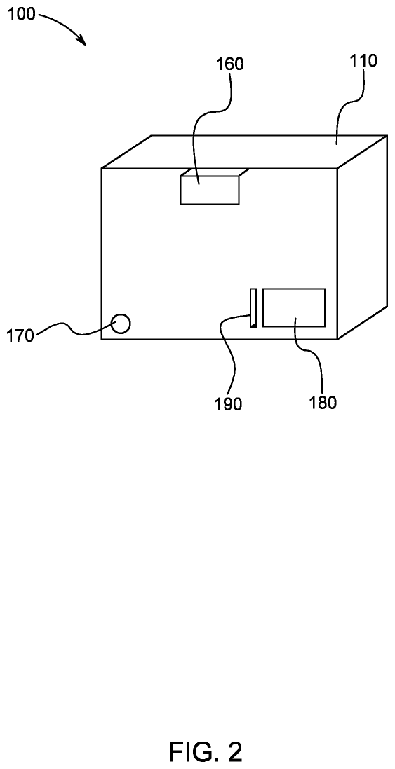

FIG. 2 illustrates a rear perspective view of the portable alarm device 100, according to an exemplary embodiment of the present general inventive concept.

The portable alarm device 100 may be constructed from at least one of metal, plastic, wood, and rubber, etc., but is not limited thereto.

The portable alarm device 100 may include a main body 110, at least one sensor 120, a communication unit 130, a storage unit 140, at least one biometric reader 150, a clip 160, a power button 170, a power source 180, and a charging port 190, but is not limited thereto.

Referring to FIGS. 1 and 2, the main body 110 is illustrated to have a rectangular prism shape. However, the main body 110 may be rectangular, circular, conical, triangular, pentagonal, hexagonal, heptagonal, octagonal, or any other shape known to one of ordinary skill in the art, but is not limited thereto.

The main body 110 may have any size. For example, the main body 110 may have a length of four inches, a width of one and a half inches, and a height of three inches. As such, the main body 110 may be portable to be hand held by a user.

The at least one sensor 120 may include a movement sensor, a temperature sensor, and/or a sound sensor, but is not limited thereto.

Furthermore, the at least one sensor 120 may have a light disposed thereon.

The at least one sensor 120 may be disposed on and/or within at least a portion of a first surface (i.e. front surface) of the main body 110. The at least one sensor 120 may illuminate a color (e.g., red) in response to detecting movement within a predetermined distance therefrom, such as five feet, ten feet, thirty feet, etc.

The communication unit 130 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

Furthermore, the communication unit 130 may include a camera connected thereto.

More specifically, the camera on the communication unit 130 may be disposed on and/or within at least a portion of the main body 110.

The storage unit 140 may include a random access memory (RAM), a read-only memory (ROM), a hard disk, a flash drive, a database connected to the Internet, cloud-based storage, Internet-based storage, or any other type of storage unit.

A mobile device 10 may include a cell phone, a tablet computer, a laptop computer, a personal digital assistant (PDA), and a watch, but is not limited thereto.

The mobile device 10 may access the Internet to allow the user to access a website, and/or may allow a mobile application and/or the software application to be executed using the mobile device. For ease of description, the mobile and/or the software application will be hereinafter referred to as an app. The app may be downloaded from the Internet to be stored on the mobile device 10.

During operation, the at least one sensor 120 may transmit an alert signal using the communication unit 130 to the mobile device 10. In other words, the mobile device 10 executing the app may facilitate communication with the communication unit 130 and/or the at least one sensor 120. Moreover, the mobile device 10 executing the app may notify on a display of the mobile device 10 a warning and/or emit a sound (e.g., a beep, a ring, a song) in response to the mobile device 10 receiving the alert signal. As such, the mobile device 10 executing the app may warn the user of movement around the at least one sensor 120, which may indicate theft and/or trespass from an intruder.

Also, the camera connected to the communication unit 130 may move from retracted within the main body 110 to at least partially extended away from the main body 110 in response to the at least one sensor 120 transmitting the alert signal. As a result, the camera connected to the communication unit 130 may record at least one image and/or at least one video thereon, such as the intruder. Subsequently, the camera connected to the communication unit 130 may move from extended away from the main body 110 to retracted within the main body 110 in response to the at least one sensor 120 detecting an absence of movement around the at least one sensor 120.

The at least one biometric reader 150 may include a fingerprint reader, an iris scanner, an eye scanner, a heart rate sensor, and a voice recognition unit, but is not limited thereto.

The at least one biometric reader 150 may be disposed within at least a portion of the main body 110 and connected to each outer surface, edge, and/or corner of the main body 110. The at least one biometric reader 150 may scan and/or detect a fingerprint and/or a toeprint in response to contact by at least one finger and/or at least one toe on each outer surface, edge, and/or corner of the main body 110. In other words, an entire outer surface of the main body 110 may be used to scan.

Furthermore, the at least one biometric reader 150 may transmit a biometric reading of the at least one finger and/or the at least one toe to the storage unit 140. As such, the fingerprint and/or the toeprint may be retrieved by the mobile device 10 using the app. Therefore, the app may provide evidence of at least one unauthorized user contacting the main body 110 that can be shared with law enforcement. For example, the at least one biometric reader 150 may provide a record of tampering, attempted tampering, and/or theft of the main body 110.

The clip 160 may be removably disposed on at least a portion of a second surface (i.e. rear surface) of the main body 110 opposite with respect to the first surface. The clip 160 may connect the main body 110 to an external object, such as a door. As such, the clip 160 may suspend the main body 110 on the door. Therefore, the main body 110 may be disposed at any position and/or any location as desired by the user while traveling, such as in a hotel room, a private home rental, and/or a vehicle.

The power button 170 may be disposed on at least a portion of the second surface of the main body 110. The power button 170 may turn on the at least one sensor 120, the communication unit 130, the storage unit 140, and/or the at least one biometric reader 150 in response to depressing the power button 170 a first time. Subsequently, the power button 170 may turn off the at least one sensor 120, the communication unit 130, the storage unit 140, and/or the at least one biometric reader 150 in response to depressing the power button 170 a second time.

The power source 180 may include a battery and a solar cell, but is not limited thereto.

The power source 180 may be disposed within at least a portion of the main body 110. The power source 180 may provide power to the at least one sensor 120, the communication unit 130, the storage unit 140, the at least one biometric reader 150, and/or the power button 170.

The charging port 190 may be disposed on and/or within at least a portion of the main body 110 and connected to the power source 180. The charging port 190 may receive an external connection therein, such as a power cord from a power outlet. Accordingly, the charging port 190 may charge the power source 180.

Therefore, the portable alarm device 100 may provide a portable solution for the user during travel to provide a security system within a hospitality accommodation. Also, the portable alarm device 100 may provide remote access to alert the user even when the user is absent from the hospitality accommodation.

The present general inventive concept may include a portable alarm device 100 connected to a mobile device 10, the portable alarm device 100 including a main body 110 having a hand held size, at least one sensor 120 disposed on and within at least a portion of the main body 110 to illuminate a color in response to detecting movement within a predetermined distance therefrom, and a communication unit 130 disposed on and within at least a portion of the main body 110 to transmit an alert signal from the at least one sensor 120 to the mobile device 10 in response to the at least one sensor 120 detecting movement within the predetermined distance.

The communication unit 130 may include a camera to move from retracted within the main body 110 to at least partially extended away from the main body 110 in response to the at least one sensor 120 transmitting the alert signal, such that the camera records at least one of at least one image and at least one video thereon based on the at least one sensor 120 detecting movement.

The portable alarm device 100 may further include at least one biometric reader 150 disposed within at least a portion of the main body 110 to scan at least one of a finger and a toe and store a biometric reading of at least one of the finger and the toe on a storage unit 140 based on at least one unauthorized user contacting the main body 110.

The at least one biometric reader 150 may scan using an entire outer surface of the main body 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A portable alarm device connected to a mobile device, the portable alarm device comprising:
a main body having a hand held size;
at least one sensor disposed on and within at least a portion of the main body to illuminate a color in response to detecting movement within a predetermined distance therefrom; and
a communication unit disposed on and within at least a portion of the main body to transmit an alert signal from the at least one sensor to the mobile device in response to the at least one sensor detecting movement within the predetermined distance.

2. The portable alarm device of claim 1, wherein the communication unit comprises:
a camera to move from retracted within the main body to at least partially extended away from the main body in response to the at least one sensor transmitting the alert signal, such that the camera records at least one of at least one image and at least one video thereon based on the at least one sensor detecting movement.

3. The portable alarm device of claim 1, further comprising:
at least one biometric reader disposed within at least a portion of the main body to scan at least one of a finger and a toe and store a biometric reading of at least one of the finger and the toe on a storage unit based on at least one unauthorized user contacting the main body.

4. The portable alarm device of claim 3, wherein the at least one biometric reader scans using an entire outer surface of the main body.
